(19) United States
(12) Patent Application Publication
(10) Pub. No.: US 2025/0139245 A1
(43) Pub. Date: May 1, 2025

(54) DETECTION OF ANOMALIES ASSOCIATED WITH INTERFERING PROCESSES

(71) Applicant: Microsoft Technology Licensing, LLC, Redmond, WA (US)

(72) Inventors: Amer Aref Hassan, Kirkland, WA (US); Roy D. KUNTZ, Kirkland, WA (US); Whitney J. GIAIMO, Bellevue, WA (US); Edward C. GIAIMO, III, Bellevue, WA (US)

(21) Appl. No.: 18/384,154

(22) Filed: Oct. 26, 2023

(51) Int. Cl. G06F 21/56

(52) U.S. Cl. CPC G06F 21/566; G06F 2221/033

(57) ABSTRACT

A system and method for detecting anomalies and malicious processes by analyzing current consumption profiles is disclosed. The technique involves generating current consumption profiles that characterize the expected power draw for known software applications operating in various modes on a target device. At runtime, the current being consumed by actively running applications is measured and compared to the total expected current draw determined from the individual profiles. Deviations between the observed and expected consumption indicate potential interference from malware or other unwanted processes. Additionally, current fluctuation profiles are generated to model the characteristic transient current behavior when applications transition between operational modes. By comparing runtime current measurements during state changes to these expected transitional profiles, the system can identify aberrations indicative of background malware triggering during the transitions. The current monitoring approach provides an efficient way to detect anomalous behavior from unwanted processes with minimal overhead.

### TECHNICAL FIELD

The present application relates to the technical field of detecting and mitigating unwanted or malicious software processes in electronic devices by monitoring electric current attributable to various software applications while those software applications are executing in various operational modes or states.

### BACKGROUND

Electronic devices like personal computers, tablet computers, and mobile phones are vulnerable to malicious attacks and unauthorized access that can impair performance and compromise data security. With the proliferation of mobile computing devices. people are increasingly using these electronic devices for sensitive communications, posing heightened risks of exposing confidential information. Mobile operating systems and software applications may contain vulnerabilities allowing malware to secretly tap microphones, cameras, and communications undetected. This presents a major privacy and security concern. Existing detection techniques, which often rely on scanning files, network traffic, and memory for known “signatures” are computationally intensive. More efficient approaches are needed that can quickly detect anomalous resource usage and unauthorized access on mobile devices. These approaches should minimize computational overhead. Effective techniques must be developed to detect unauthorized access to communication interfaces on mobile devices. This will help prevent exploitation by malicious actors seeking to compromise sensitive information.

### BRIEF DESCRIPTION OF THE DRAWINGS

Embodiments of the present invention are illustrated by way of example and not limitation in the figures of the accompanying drawings, in which:

FIG. 1 is a schematic diagram illustrating an example of common hardware components of a client computing device that are consistent with embodiments of the invention and capable of detecting malicious software processes via monitoring of current consumption.

FIG. 2 is a diagram illustrating an example of a database of (electric) current consumption profiles, where each individual current consumption profile indicates an expected amount of current to be consumed by a computing device attributable to a software application known to be executing in a particular operational mode or state, consistent with some embodiments.

FIG. 3 is a diagram illustrating an example of a database of current consumption profiles, where each individual current consumption profile represents an expected amount of current consumed by a particular hardware component or hardware resource that is attributable to a software application known to be executing in a particular operational mode or state, consistent with some embodiments.

FIG. 4 is a diagram illustrating an example of a database of current consumption profiles, where each individual current consumption profile indicates an expected amount of current drawn by the computing device over a period of time during which a software application is known to transition from one operational mode or state to another operational mode or state, consistent with some embodiments.

FIG. 5 is a diagram illustrating an example bar chart depicting a bar representing the expected overall current of a computing device executing three software applications in specific operational modes, as derived from their respective current configuration profiles, consistent with some embodiments.

FIG. 6 is a flow diagram illustrating an example of a method for detecting anomalies in overall current consumption, consistent with embodiments of the invention.

FIG. 7 is a block diagram illustrating a software architecture, which can be installed on any of a variety of computing devices to perform methods consistent with those described herein.

FIG. 8 illustrates a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are methods and systems for detecting and mitigating unwanted or malicious software processes in electronic devices by monitoring electric current. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

Malicious software processes such as viruses, worms, and trojans are especially problematic when leveraged to spy on users by illicitly tapping into unified communications facilitated by software applications. Here, the concept of unified communications refers to the integration of modalities like voice, video, messaging, and conferencing into software applications that provide seamless workflows between users across devices and platforms. When malware is able to stealthily intercept or access these communications, it enables spying and surveillance that severely compromises user privacy and security. For example, an undesirable software process could unknowingly tap into a software video conferencing application to silently eavesdrop on a meeting, by redirecting a stream of data to a bad actor. Similarly, a virus might be able to access messages sent through a chat or text-based messaging application and secretly forward copies of sensitive conversations to unauthorized parties. This type of tapping by malware to spy on unified communications channels represents a dangerous threat, yet detection using conventional security techniques has proven challenging.

Signature-based detection techniques have been used as one approach for identifying malware and undesirable processes on computing devices. With signature-based detection, unique patterns or identifiers associated with known threats and undesirable processes are pre-defined and stored in a database. These signatures may be based on aspects such as specific code sequences, instruction opcodes, network traffic patterns, file modifications, registry edits, or other artifacts and behaviors indicative of a specific threat. To detect threats, software applications will scan target code, network packets, memory, and storage, looking for matches to these pre-defined signatures. Typically fast pattern matching algorithms are utilized to efficiently search for signature matches within the target data. Signature detection forms the basis for many antivirus and intrusion detection systems on computing platforms.

However, signature-based approaches have several notable disadvantages. Signature detection requires the ongoing maintenance of a large database containing signatures for known threats and frequent updates to this database as new threats are discovered. Fundamentally, signature detection can only identify threats for which a signature has already been identified and cataloged. The scanning process itself consumes significant processing resources, often utilizing intensive computation to search for many possible signature matches within the target data. Consequently, this scanning significantly increases power consumption, which is especially prohibitive on battery-constrained mobile platforms. Additionally, signature detection techniques cannot generalize to detect zero-day threats or polymorphic malware that alters its code patterns to evade signatures. Signature-based approaches are further susceptible to evasion through obfuscation or modification of the attack's identifiable patterns and artifacts.

Another approach to detecting malware involves heuristic-based detection techniques. Heuristic-based detection techniques take a more analytical approach to identifying malware and unwanted processes, in contrast to strict signature matching. With heuristic-based detection, algorithms are used to evaluate various properties associated with executable files, system behaviors, and other artifacts. These algorithms apply heuristics to analyze factors like file metadata, structure, binary patterns, API and system calls, network communications, registry and file system access, and more. The goal is to detect artifacts and behaviors that appear anomalous or “suspicious” based on heuristics that characterize normal or benign system activities. This enables the algorithms to flag unknown threats that may lack a specific signature match. Heuristic detection is generally less precise than signature matching, however it can potentially identify novel threats.

However, heuristic-based detection still retains some notable disadvantages that limit its effectiveness and applicability. The heuristic algorithms require significant processing overhead to analyze the various factors and make probabilistic determinations on threats. This processing overhead consumes substantial computing resources and battery on mobile platforms. The algorithms also have a tendency to generate false positives for benign system events that happen to match heuristic rules for suspicious activity. Tweaking the heuristics to reduce false positives risks increasing false negatives and missing threats. Further, threat actors can potentially analyze the detection algorithms and craft malware that avoids triggering heuristic rules. While heuristic detection has advantages over strict signature matching, it remains a computationally demanding approach with accuracy challenges.

Consistent with embodiments of the present invention, an anomaly-detection based approach, having two primary stages or parts, is described. During a first stage, a local database of current consumption profiles is created on a target device, where each current consumption profile represents an expected current draw for a given application operating in a specific state or mode. The second stage is real-time anomaly detection, where the current being consumed during operation of the device is continually measured and compared against expected current levels derived from the current configuration profiles of all applications currently executing. Deviation between observed and expected current consumption based on the profiles indicates potential interference from malware or other unwanted processes, triggering alerts or other actions. By combining pre-characterization of per-application current profiles, executing in specific operational modes, with runtime monitoring and comparison, embodiments of the invention provide an effective approach to detecting anomalous current behavior suggestive of malicious activity.

The current consumption profiles that characterize software application states can be derived in at least one of two ways. First, the current consumption profiles may be pre-characterized on a known clean test machine that is free of any malware or interfering processes. The target software applications are individually profiled in isolation to generate the characteristic current draw profiles. These profiles are then transferred and installed on the target devices that will utilize them for monitoring operations. Alternatively, the profiling software can reside directly on the target device itself. During initial setup when the device is secure, the profiling software methodically exercises the various applications and modes, measuring the resulting current draw to populate the database with entries mapping software states to expected current levels. Once the target device profiles have been compiled, the software may disable further modification to prevent tampering. Alternatively, the profiling process may periodically re-execute on a scheduled basis to re-measure and confirm the prior current consumption values, generating a notification flag if any updated value deviates from the original by more than a defined threshold amount.

Importantly, when the current consumption profiles are generated on a known clean test machine, the current consumption profiles are constructed for the specific target device hardware configuration, since factors like the CPU, network interface, GPU, etc. will influence current draw. The same software application executing a video conferencing feature on two different computing devices may exhibit different current consumption profiles. Once generated on the clean machine, the database of current consumption profiles can be transferred to the target device for monitoring operations. By profiling normal current consumption for software states on the target hardware, any runtime deviations can be flagged as anomalies.

In some embodiments, a remote server-based service may maintain a comprehensive database containing current consumption profiles for a wide variety of computing device hardware configurations and software versions. When the profiling software first executes on a target client device, it can communicate details of the device's hardware components (e.g. CPU model, GPU model, amount of RAM, etc.) and software versions to the remote service. The service can then query its database and identify the appropriate current consumption profiles that match the target device's configuration. These matched current consumption profiles are then downloaded and installed locally on the target device for use in monitoring and anomaly detection. By leveraging a remote server-based service in this manner, the system can support anomaly detection across many different device models and platforms while avoiding the need to individually profile each target device from scratch.

The current consumption profiles that characterize software application states can be represented in different ways, and may vary based on whether a software application is executing in a steady state—that is, in the same operational state or mode over a given period of time—or alternatively, transitioning operational modes, for example, from a first mode or state to another mode or state. One approach is to define the expected current draw for a given operational state of a software application using a single numeric value, such as 0.5 amps. This single value may be derived as the average observed current consumption of several sample measurements over some brief period of time, recognizing that there may be slight variations over time. Factors like computational load, data rate, and environmental conditions can cause these minor fluctuations in current around an average level.

As an alternative to specifying a current consumption profile as a single number, a current consumption profile can alternatively be specified as a range of values, such as 0.5 amps to 0.6 amps. Defining the anticipated current draw for a software application operating in a particular mode or state using a range provides tolerance for routine fluctuations during operation. It enables the same overall current behavior to be captured without flagging normal variations as anomalies. Specifying expected current for profiles as ranges rather than discrete values also allows the sensitivity of anomaly detection to be tuned based on the range size. A narrow range will detect smaller deviations, while a wider range may ignore insignificant fluctuations and only identify meaningful anomalies outside the range. The appropriate range size can be determined experimentally for each operational state to optimize detection accuracy.

Whether represented as discrete values or ranges, the current consumption profiles characterize baseline current draw for software applications in different operational modes. To detect anomalies, the current consumption profiles for actively executing applications are summed to derive an expected overall current draw. For example, if three applications (APPLICATION #1, APPLICATION #2, and APPLICATION #3) are executing, their individual current consumption profiles for the specific operational state are retrieved and added together. The resulting summed value represents the total overall expected current consumption with all three applications executing. The derived overall expected current is then compared to the actual overall observed current consumption. If the observed current consumption significantly exceeds the summed expected draw, this deviation indicates potential interference from malware or other unwanted processes. By summing the individual application current consumption profiles and comparing to real-time measurements, the system can reliably detect anomalies caused by additional current draw from malicious background activities.

With some embodiments, in addition to current profiles for software applications and operational states, the current consumption profiles database can also contain separate current consumption profiles for individual hardware components like the CPU, GPU, network interface, memory, storage, etc. These fine-grained current consumption profiles are associated with utilization of specific hardware resources by particular software when operating in a specific operation mode or state, rather than overall current draw. The hardware-level profiles provide deeper insight that can be leveraged when an anomaly is detected but the deviation between observed and expected total current is within a grey area threshold. In this case, the current consumption of individual components can be checked against expected values to isolate the source of the anomaly.

For example, if a video conferencing application is executing with higher than anticipated total current, the network interface and GPU current draw could be analyzed. If the network interface current matches expectations but the GPU draw is abnormally high, this suggests the anomaly is arising from graphics processing rather than network activity.

By profiling and analyzing current consumption at both the overall software application level as well as the underlying hardware resource level, embodiments of the invention provide precise anomaly detection. The hardware-level current analysis serves as an additional verification mechanism when anomalies are detected but the source is ambiguous. Isolating the anomalous current draw to specific hardware resources may help to facilitate more targeted remediation as well.

With some embodiments, in addition to steady-state current consumption profiles, the current consumption profile database may also include profiles capturing current consumption for individual software applications during transitions between operational modes. For example, when a video streaming software application shifts from standby or idle into actively transmitting or receiving high-bitrate video, the current consumption of the device ramps up, exhibiting a specific curve over time. The shape of this current ramp-up acts as a unique current consumption profile associated with that software transitioning between those two states.

In some instances, these transition current consumption profiles can detect anomalies more accurately than steady-state current consumption profiles. This is because the dynamic current curve is characteristic of the particular software and hardware involved in the state change. It is more difficult for malicious software to emulate the precise current fluctuation behavior when an application shifts operational state or mode. By comparing observed current ramps against expected current ramps during software state changes, unwanted background processes interfering with or triggered by the transition can be detected. Using current profiles for both steady-state modes and transient transitions provides robust anomaly detection capabilities.

Consistent with embodiments of the present invention, the second stage involves real-time monitoring and analysis of current consumption to detect anomalies that may indicate presence of malware or other interference. During operation, the set of software applications currently executing is identified along with their respective operational states. The current consumption profiles corresponding to these software applications and states are retrieved from the pre-constructed database. The individual current consumption profiles are combined (e.g., summed) to estimate the overall expected current draw by the combination of executing software applications.

Periodically, such as every few seconds, the actual current consumption is measured using ammeters or other sensor equipment. The observed current is compared to the expected current level derived from the current configuration profiles of the actively executing software applications. If the observed current exceeds the expected current by more than a defined threshold, this deviation is interpreted as an anomaly potentially caused by malicious or unwanted processes. As a result, one or more actions may be taken such as generating an alert to the user warning of potential malicious activity, disconnecting the device from the network to prevent further communication, shutting down unnecessary background processes to isolate the anomaly, activating additional security scanning to identify the source of the anomaly, initiating a system restore or reboot to clear any potential malware, or transmitting analytics data to a backend service to further analyze the anomaly.

However, more sophisticated analysis can be employed when an anomaly is detected but the deviation is within a defined “grey area” that does not clearly indicate a threat. For instance, this grey area may be defined by an observed current consumption that is greater than the expected current consumption (e.g., based on the current consumption profiles of the currently executing software applications in their respective operational modes or states), but less than some predetermined, or dynamically determined, threshold. In such cases, individual current consumption may be measured for specific hardware components like the CPU, network interface, memory, etc. This per-component current can be compared to expected values for the currently executing software applications to isolate any specific components showing abnormal draw.

For example, if expected current for the combination of software applications is 1 amp but 1.2 amps is observed, with the network interface drawing 0.4 amps compared to an expected 0.2 amps, this suggests the anomaly is linked to excess network activity. By targeting current profiling and comparison to both overall device consumption as well as individual hardware components, some embodiments provide robust threat detection capabilities.

Consistent with some embodiments, periodically sampling the current consumption allows the system to regularly check for current anomalies rather than continuously monitoring current. This provides an efficient compromise between anomaly detection responsiveness and computational overhead. The sampling rate can be tuned based on factors like application activity levels. For example, a higher sampling rate may be used when applications are actively running compared to idle states. Additionally, the sampling rate may be adjusted based on the specific operational state or mode of applications. For example, higher sampling rates may be used when applications are in communication states like audio or video calls compared to locally running computationally intensive tasks, due to the increased privacy and security risks associated with remote communications. The sampling frequency can be adapted based on device state to optimize accuracy and efficiency. A higher sampling rate during active use ensures anomalies are caught promptly. A lower sampling rate during idle states reduces resource usage while still checking for anomalies. The system can adjust the sampling frequency automatically based on monitoring application execution. Furthermore, temporarily increasing the sampling rate after detecting an anomaly allows additional measurements to be gathered for further analysis. The higher resolution data can be used to better characterize the anomaly and determine an appropriate response. After the detailed analysis, the sampling rate can be returned to normal levels. This adaptive sampling approach provides high resolution when needed without constant overhead.

In addition to monitoring for current anomalies based on steady-state current consumption profiles, the current consumption profiles database may also include current consumption profiles capturing current consumption for software applications during transitions between operational modes or states. For example, when a video streaming application shifts from standby or idle into actively transmitting high-bitrate video, the current consumption of the device ramps up in a characteristic curve over time. The shape of this current ramp-up acts as a unique profile tied to that software transitioning between those two states. By pre-characterizing the current profiles for major state changes of software applications, these transition current consumption profiles can be used to detect anomalies. During actual usage, the current consumption is monitored when transitions occur, and the observed or measured current consumption is compared to the expected current consumption as indicated in the corresponding current consumption profile for that event. If additional current is detected, deviating from the expected current consumption profile, this discrepancy suggests unwanted background processes interfering with, or perhaps being triggered by, the state change of the software application.

Existing signature-based and heuristic-based techniques for detecting malware and unwanted software processes require extensive computational resources to scan system code and memory or perform complex analysis. This heavy processing overhead presents a technical problem for efficient security on mobile platforms with limited computing capacity like phones and tablets. In contrast, the current monitoring approach provides a targeted technical solution by analyzing current flows attributable to software processes. This lightweight current flow analysis avoids expensive (e.g., computationally intensive) signature matching and heuristic algorithms. The minimal computational requirements enable the current monitoring technique to operate efficiently even on resource-constrained mobile devices, providing effective threat detection without excessive battery drain or processing usage, thereby literally improving how these devices function.

Broad analysis of system properties under heuristic techniques has technical shortcomings of inaccurate results and high computational load. Deriving complex heuristic algorithms presents another technical challenge. The current monitoring approach described herein offers a streamlined technical solution by specifically analyzing current flows linked to software execution, avoiding imprecise and demanding heuristics. The technical focus on current behavior provides efficient and accurate threat detection. By pre-characterizing expected current profiles and comparing these to runtime measurements, the current monitoring approach reliably identifies anomalies and unknown threats without reliance on signatures or heuristics. The technical efficiency of directly monitoring current flows provides advantages over prior techniques, and improves the functioning of devices.

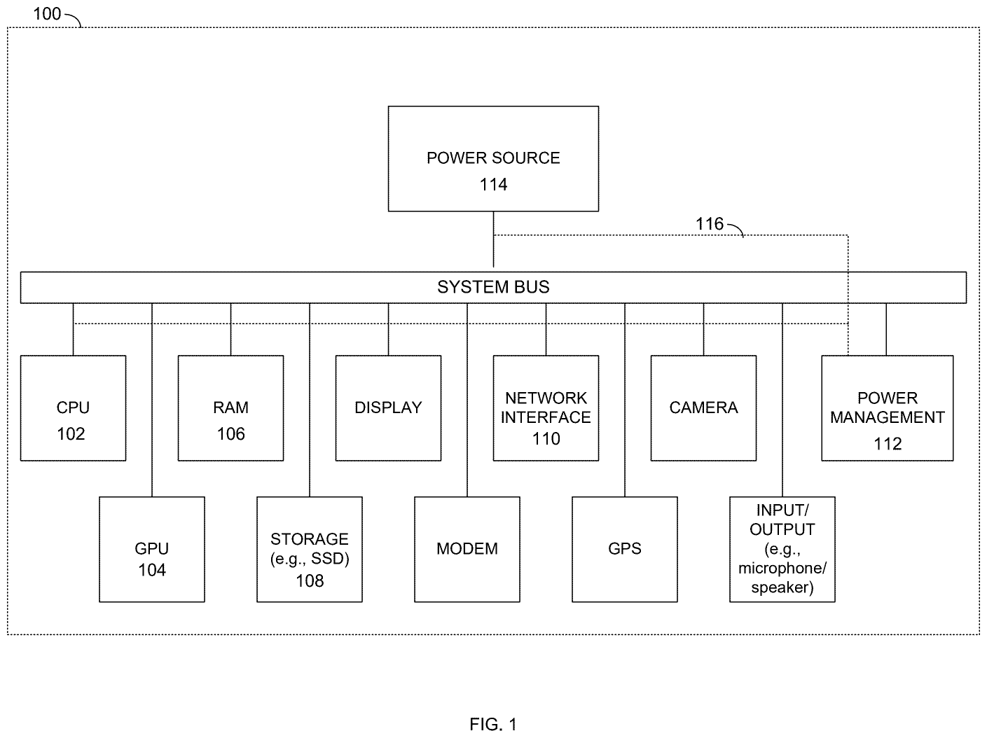

FIG. 1 is a schematic diagram illustrating an example of common hardware components of a client computing device 100 consistent with embodiments of the invention and capable of detecting malicious software processes via monitoring of current consumption. The computing device 100 depicted in FIG. 1 includes various hardware components that draw current during operation—and specifically, different amounts of current during execution of different software applications when operating in various operational states or modes. These components include, for example, the central processing unit CPU 102, graphics processing unit (GPU) 104, random access memory (RAM) 106, storage 108, network interface 110, power management 112, power source 114, and others.

The computing device 100 includes functionality to identify software applications currently executing on the device and determine the operational state or mode of each application. This can be accomplished using standard operating system APIs and functions. For example, calls can be made to get lists of running processes and background services. The state of applications can be determined by monitoring API calls from those processes to system resources and libraries. For instance, initiating a call to video rendering libraries indicates an application is entering a video streaming state. Network activity associated with an application process implies a data transfer mode. The application tracking component could also interface with application frameworks to get state information directly from the apps themselves. By leveraging operating system functions and application frameworks, the system can maintain real-time knowledge of active software applications and their states needed to drive the anomaly detection approach.

To measure overall current consumption, the device may utilize ammeters, such as on the power rail 116 from the power source 114 before it branches out to individual components. This allows measurement of total current into the device. Additionally, current sense resistors can be positioned in line with power connections to specific components. By measuring the voltage drop across these resistors, the current draw of individual components can be determined.

For example, a current sense resistor may be connected in series between the power source 114 and the CPU 102 power input. By measuring the voltage drop across this resistor, the current draw of the CPU 102 can be measured in real time. Similar resistors can be added to the power path for the GPU 104, RAM 106, storage 108, network interface 110, and other components. This enables itemized measurement of current consumption by specific hardware resources. The voltage drops can be sampled by on-chip analog-to-digital converters and the measurements used by monitoring software.

In another implementation, the current sense resistors may be integrated on-die with the various hardware components, enabling precise current measurements for each hardware component or resource. The integrated current sense outputs can be routed to monitoring circuitry. This provides a comprehensive view of overall device current consumption as well as granular visibility into current draw by individual hardware components. The combined data enables robust anomaly detection.

The computing device and components depicted in FIG. 1 provide just one example implementation consistent with some embodiments of the invention. A person skilled in the art will recognize that in alternative embodiments, various components shown as separate elements in FIG. 1 could be combined or integrated into single components or chips. For instance, the CPU and GPU could be integrated into a single accelerated processing unit (APU). The RAM could be integrated into the CPU die to create a system-on-a-chip (SoC). Various controllers and interfaces could be combined into a single chipset. These and other variations on the example architecture and components of the device illustrated in FIG. 1 could be implemented without departing from the spirit of the techniques described herein. The example computing device illustrated in FIG. 1 is not intended to limit the invention to the specific components shown.

While the techniques described herein can be applied to any computing device, they are particularly applicable to client computing devices that may be vulnerable to malware, such as phones, tablets, laptops, and desktop computers. For these client devices that handle private user data and communication, unauthorized surveillance and access poses a major security risk. However, the invention could also be applied to improve security on server-based computing systems. Although servers may be less susceptible than client computing devices, they still face risks from viruses, worms, and unauthorized access. Applying current monitoring on servers provides another layer of protection to ensure critical business systems and data remain secure from anomalies and unwanted processes. Thus, while client devices are emphasized herein, the current monitoring approach described herein can help strengthen cybersecurity for server computers as well.

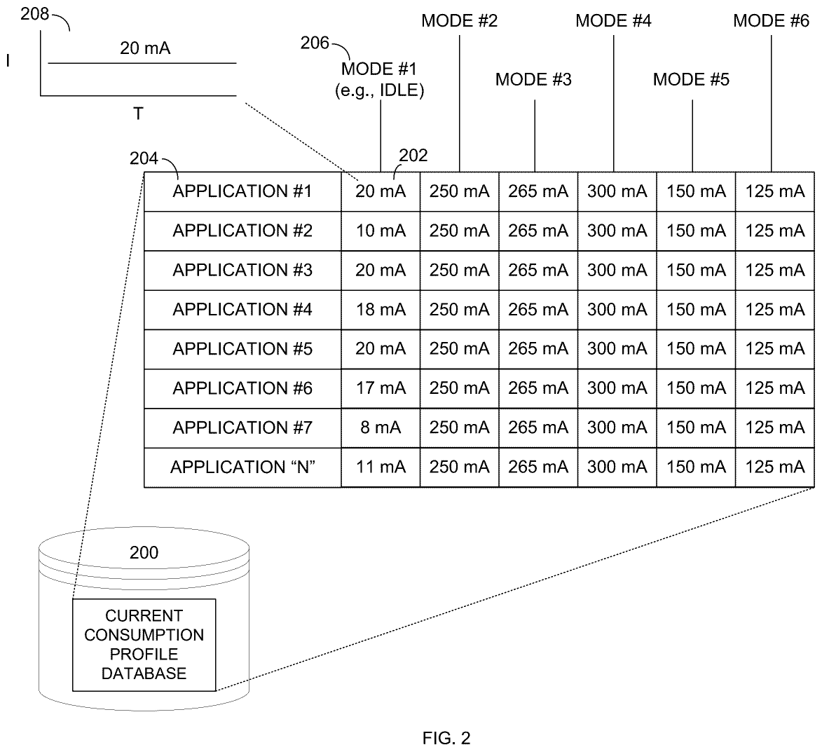

FIG. 2 is a diagram illustrating an example of a database 200 of (electric) current consumption profiles, where each individual current consumption profile indicates an expected amount of current to be consumed by a computing device 100 attributable to a software application known to be executing in a particular operational mode or state, consistent with some embodiments. Specifically. FIG. 2 depicts an example current consumption profile database 200 containing a number of entries—for example, such as the entry 202—where each entry 202 corresponds with a software application operating in a specific operational mode or state. For example, the current consumption profile corresponding with the table entry with reference 202 is the current consumption profile for the software application 204 (e.g., “APPLICATION #1”) operating in a first operational mode 206 (e.g., “MODE #1). For a given application 204, the database 200 contains one or more current consumption profiles, where each current consumption profile indicates an expected electric current draw attributable to execution of the corresponding software application in the associated operational state. The graph 208 shown in the upper left section of FIG. 2 provides a visual representation depicting the steady-state current consumption profile for software application 204 (e.g., “APPLICATION #1”) executing in a particular operational mode 206 (e.g., “MODE #1”).

In the example illustrated in FIG. 2, the software application 204 (“APPLICATION #1”) has six current consumption profiles, each representing an expected current draw for one of six different operational modes, labeled as “MODE #1” through “MODE #6”. When the software application 204 is executing in the first mode 206, which could represent an idle state, the expected current draw is 20 mA. In a second mode (e.g., “MODE #2”), which could be an audio communication state, the expected current draw is 125 mA. The other modes—for example, “MODE #3” through “MODE #6”—each have expected current draws ranging from 125 mA to 300 mA.

A software application executing on a computing device 100 operates in various operational modes or states. In the context of the present application, an operational mode or state refers to the software application operating to perform a particular function, a particular task, or a particular operation at a given time. For instance, common operational modes or states for applications may include:
Idle—The application is open but not being actively used.
Active Communication—The application is facilitating an active communication session like an audio call, video call, chat/messaging, or conference call.
Media Playback—The application is playing or streaming video or audio content. This could include states like paused, playing, fast forwarding, rewinding, variable bitrate playback, etc.
Gaming—The application is executing an interactive game application. The operational state may be correlated with factors like rendering quality and frame rate.
File Transfer—The application is actively downloading or uploading data. Operational states could represent different transfer speeds.
Video Playback—Playing locally stored video content. States could include paused, playing, scrubbing, etc.
Audio Playback—Playing locally stored audio content. States could include paused, playing, variable bitrate playback.
Computational Task—The application is performing intensive computations like processing images/video, crunching numbers, training machine learning models, etc.
Transition—The application is transitioning from one operational state to another.

The above list represents common operational modes or states but is not exhaustive. Additional application-specific operational modes or states are also possible. The current consumption profile varies based on the particular operational state.

In some embodiments, the operational modes or states of the individual software applications may be defined at a very granular and specific level, to include individual operational modes for different video resolutions, bit rates, frame rates, codec parameters, and other characteristics. For example, a video streaming application may have distinct operational states for 480p streaming, 720p streaming, 1080p streaming. 4K streaming, and so on. The granularity depends upon the impact the different modes have on, and the differences between, expected current draws. A video conferencing application could have operational states for different bandwidths or bitrates, such as high definition video conferencing, standard definition video conferencing, and low bandwidth video conferencing. Defining operational states at this level of specificity allows current consumption profiles to accurately capture minor variations in current draw that may be indicative of anomalies. However, more generalized operational state definitions may be sufficient in many implementations.

Although not illustrated in FIG. 2, with some embodiments, the current consumption profiles may include multiple current consumptio profiles for a given software application and operational state to account for different versions or configurations of the software application. For example, a video streaming application may have slightly different current draws depending on the version number, codec used, resolution settings, and other factors. By storing current profiles for the various configurations, anomaly detection can remain accurate across application updates and setting changes.

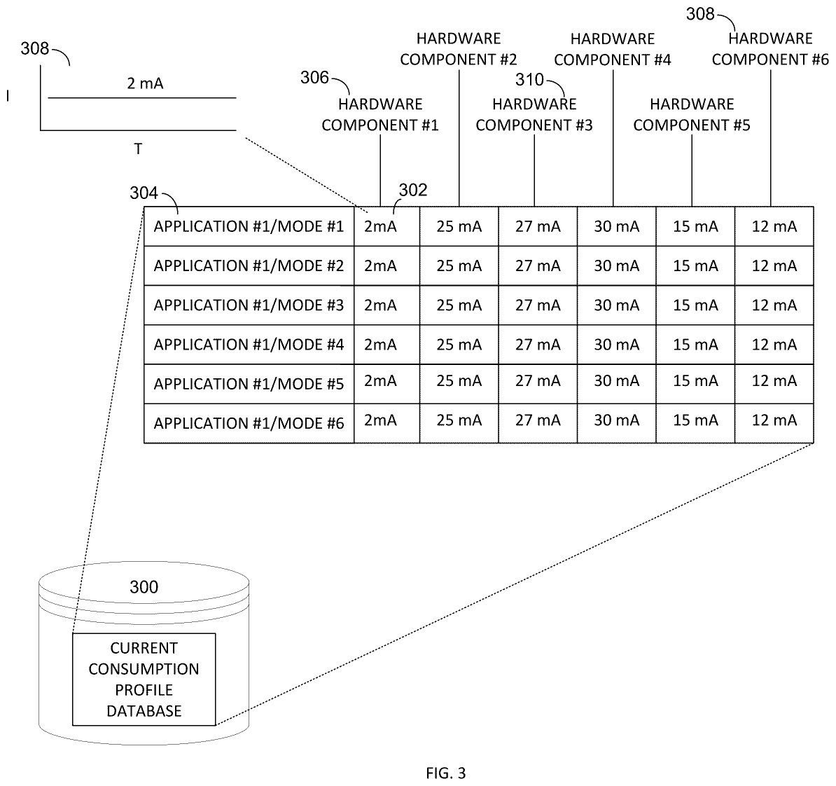

FIG. 3 is a diagram illustrating an example of a database 300 of current consumption profiles, where each individual current consumption profile represents an expected amount of current consumed by a particular hardware component or resource that is attributable to a software application known to be executing in a particular operational mode or state, consistent with some embodiments. Specifically, FIG. 3 depicts a database 300 containing granular current consumption profiles for individual hardware components (e.g., CPU 102, GPU 104, network interface 110, etc.) utilized by various software applications executing in different operational modes. The database 300 includes entries, such as entry 302, mapping a software application and operational mode pair to expected current draws for specific hardware resources like the CPU 102, GPU 104, network interface 110, and so forth. For instance, when the first application 304, referred to in FIG. 3 as “APPLICATION #1”, is operating in the first mode, referred to as “MODE #1”, the expected current draw for the CPU (e.g., “HARDWARE COMPONENT #1” 306) is 2 mA, as indicated by the entry with reference 302. Similarly, for the same software application and mode, the current draw for the network interface (e.g., “HARDWARE COMPONENT #6” 308) is 12 mA, and for the GPU (e.g., “HARDWARE COMPONENT #3” 310), 27 mA, and so on. By profiling current consumption at the hardware component level in addition to the software application and operational mode level, the database 300 enables precise anomaly detection and root cause analysis capabilities. When an anomaly is detected or suspected based on the observed overall current being in excessive of expected current, as determined from the current consumption profiles, the hardware-level profiles can be analyzed to isolate the specific component exhibiting abnormal current draw; which can inform targeted remediation actions.

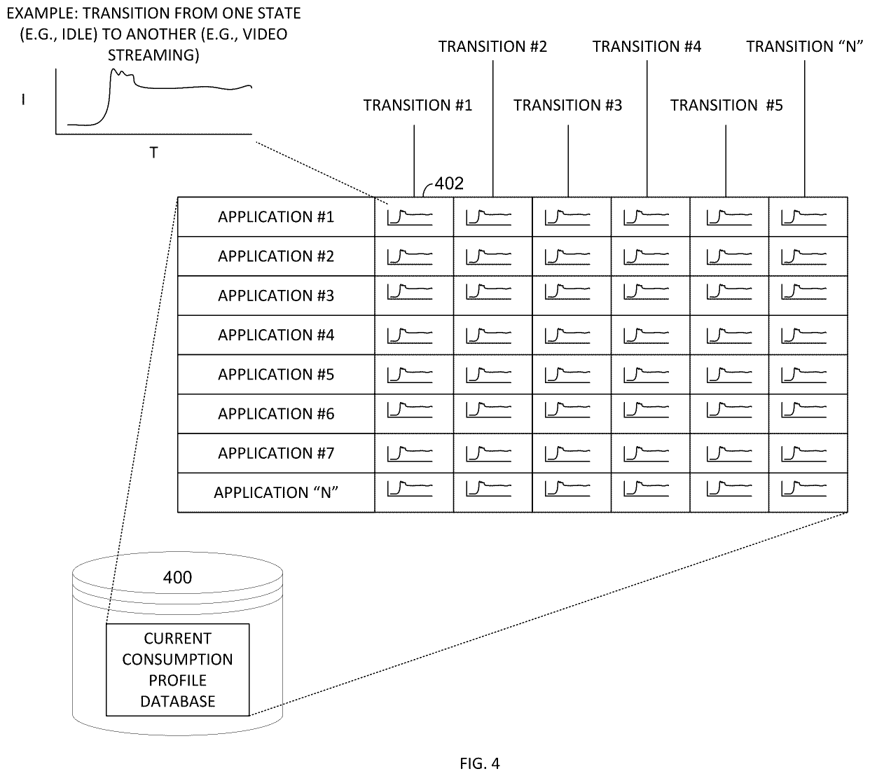

FIG. 4 is a diagram illustrating an example of a database 400 of current profiles, where each individual current profile indicates an expected amount of current drawn by the computing device over a period of time during which a software application is known to transition from one operational mode or state to another operational mode or state, consistent with some embodiments. Consistent with some embodiments, in addition to steady-state current consumption profiles, the current consumption profile database 400, as illustrated in FIG. 4, contains current consumption profiles capturing current consumption during transitions between operational modes or states, for a software application. In FIG. 4, each individual entry, such as the entry with reference number 402, represents a current consumption profile for a software application that is transitioning from one operational mode or state to another. For example, when a video streaming application shifts from idle into actively transmitting high-bitrate video, the computing device's current consumption ramps up in a characteristic curve over time. The shape of this current ramp-up acts as a unique current consumption profile tied to that software transitioning between those two states. By pre-characterizing the current profiles for major state changes of software applications, these current consumption profiles can be used to detect anomalies and malicious processes.

During actual usage, the overall current consumption is monitored when transitions occur, and the overall observed current is compared to the expected current as derived from the various current consumption profiles for the various software applications, and in particular the software application that is exhibiting the transition event. If additional current above and beyond the expected current is detected, deviating from the expected profile, this discrepancy suggests the possibility of an unwanted background processes interfering with or triggered by the state change. By comparing observed current ramps against expected current ramps during software state changes, unwanted processes that may be stealthily tapping into communications can be detected. Using current profiles for both steady-state modes and transient transitions provides robust anomaly detection capabilities.

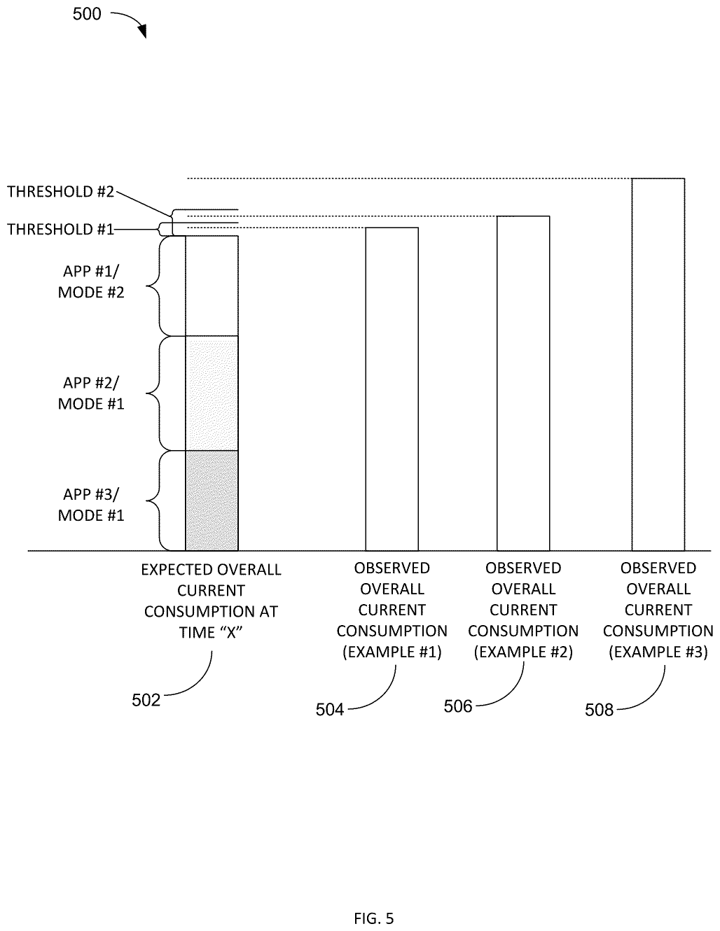

FIG. 5 illustrates a bar chart 500 depicting how the overall expected current consumption for a computing device, at a moment in time or over a small amount of time, is compared with the overall observed current consumption, to ascertain whether an undesirable software process may be executing on the computing device. In FIG. 5, the bar with reference number 502 represents the expected overall current consumption, at a particular moment in time. The expected overall current consumption is derived by first identifying the executing software applications and their respective operational modes or states. The device then obtains the current consumption profiles corresponding to each executing application-state pair from the current consumption profile database. These individual current consumption profiles are combined (e.g. summed) to arrive at an expected overall current consumption value.

This is depicted in FIG. 5 by the bar 502, representing the combined expected current amounts for APPLICATION #1 in MODE #2, APPLICATION #2 in MODE #1, and APPLICATION #3 in MODE #1. As shown in FIG. 5, the expected overall current is compared against actual observed measurements. Three examples are presented.

The bar with reference number 504 represents a first example observed overall current that exceeds the expected current but is less than a first threshold. This first threshold allows for some minimal variance without necessarily indicating current anomalies. If the observed current is below the first threshold, it is likely within normal fluctuations and a determination may be made that no malware is present. The first threshold that is used to determine if a current anomaly exists can be predefined or dynamically determined. As a predefined threshold, it could be set as a fixed value like 5% above the expected current. Alternatively, the threshold can be dynamically determined based on current system conditions and current consumption profiles, including:
The threshold may be adjusted based on the number of software applications currently executing. More apps running leads to a higher total expected current, so the threshold can scale proportionally.
The operational modes/states of active apps can influence the threshold. Threshold may be higher for resource-intensive states like gaming vs idle.
The expected current values themselves can factor into dynamic threshold setting. For apps with higher current profiles, the threshold can be increased proportionally.
Machine learning algorithms can tune the threshold over time based on measured current consumption patterns and anomaly rates.
Threshold can be made adaptive to account for fluctuations in environmental conditions like temperature.

By dynamically adjusting the first threshold using these and other criteria, the device can achieve an optimal balance of anomaly detection sensitivity and false positive avoidance. The dynamic threshold accounts for context to improve accuracy.

The bar with reference number 506 represents an observed overall current exceeding both the expected current consumption and the first threshold, but less than a second threshold (e.g., “THRESHOLD #2”). This “grey area” may require additional analysis to confirm if a current anomaly represents an unwanted software process. Current consumption may be checked at the individual hardware component level to isolate the source of the current anomaly, and additional analysis may be performed before confirming a rogue process and taking preventative action.

The bar with reference number 508 represents an observed overall current exceeding the expected overall current consumption, the first threshold, and the second threshold, indicating a high likelihood of an unwanted process executing on the device. In this case, immediate actions like disconnecting the network, shutting down the device, or executing a remediation procedure may be taken. The specific response can be tailored based on the threshold exceeded, or by performing some additional analyses to determine the nature of the software application that is causing the current to exceed expectations.

The example bar chart of FIG. 5 illustrates one approach for comparing expected versus observed current to detect anomalies potentially caused by unwanted software processes. However, those skilled in the art will recognize that other techniques are also consistent with embodiments of the present invention. Specifically, in some alternative embodiments, a single threshold, set to be some value in excess of the expected current consumption as derived from the corresponding current consumption profiles, may be defined and utilized to distinguish between current anomalies having a low likelihood of being attributable to unwanted software processes, versus current anomalies having a high likelihood of being caused by unwanted processes. Exceeding this single threshold indicates a current anomaly that does not require further analysis before direct remedial action is taken. The particular thresholding approach does not limit the invention.

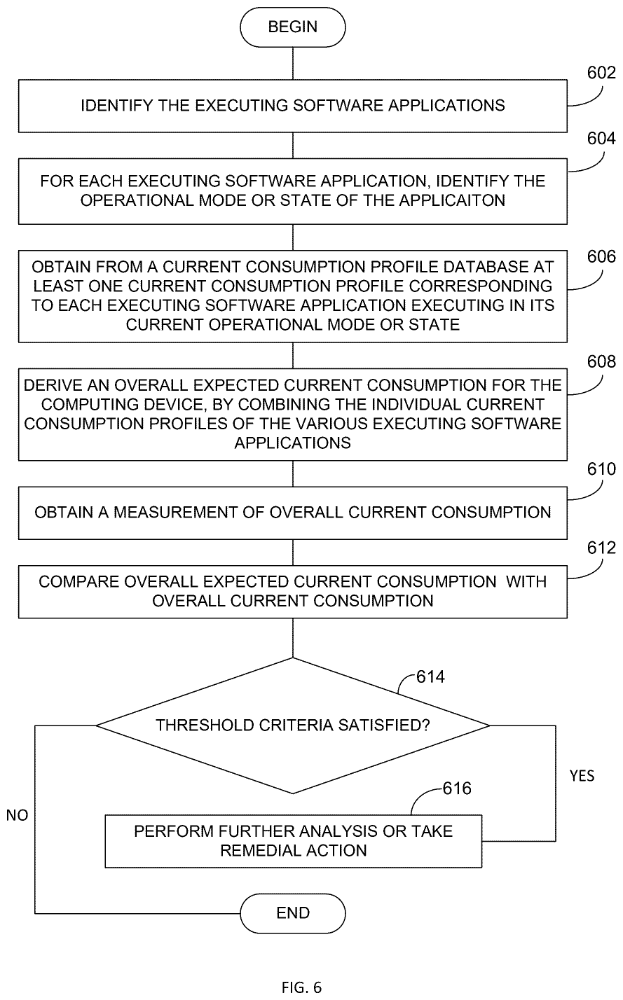

FIG. 6 illustrates a flow diagram of a method 600 for detecting anomalous current consumption in a computing device, consistent with some embodiments. The method begins at step 602, where the client computing device identifies any software applications currently executing. The client computing device can check with the operating system to get a list of all processes and services currently executing. Additionally, or alternatively, a monitoring process on the computing device can proactively monitor and record when applications get launched by the user. The client computing device may also utilize application monitoring APIs provided by the operating system to receive notifications when applications start up or shut down. Furthermore, the client computing device can leverage hooks into application launchers and application managers to identify applications as they are initialized. By utilizing these various operating system facilities, the computing device can robustly track and identify software applications that are currently executing at any given time.

At step 604, for each executing software application, the device determines the application's operational state, representing the function or task currently being performed by the application. In some implementations, the identification of executing software applications (e.g., method operation 602) and determination of their operational modes/states may be performed together in a single step, such as by making a call to an operating system service or database that returns both the executing applications and their current operational states. In other embodiments, there are a variety of different ways that the operational mode or state of the software application may be determined. For example, with some embodiments, the operating system of the computing device may have processes and resource monitoring services that facilitate the tracking and logging of resource usage, from which the computing device may infer application mode or state. The computing device may leverage various techniques like hooks into applications and application programming interfaces to get mode or state information. In some examples, each software application may log or provide a callback function that is published with state information. In yet other examples, the computing device could maintain its own application state log information.

Next, at method operation 606, the computing device accesses a current consumption profile database of current consumption profiles. For instance, for each combination or pairing of a software application and corresponding operational state, the computing device obtains a current consumption profile indicating the expected current consumption of the software application when executing in the operational mode or state.

At step 608, the current consumption profiles of the executing software applications are combined to calculate an overall expected current draw by the computing device. When the individual current consumption profiles are represented as discrete values, the overall expected current draw may be calculated as the sum of these discrete current values. For example, if a first application has an expected current of 0.2 amps, a second application has an expected current of 0.3 amps, and a third application has an expected current of 0.1 amps, the overall expected current would be 0.2+0.3+0.1=0.6 amps.

However, when the individual current consumption profiles are expressed as ranges of values, the overall expected current draw may be calculated using the range extremes or midpoints. For instance, if a first application has an expected current range of 0.18 to 0.22 amps, a second application has a range of 0.25 to 0.35 amps, and a third application has a range of 0.08 to 0.12 amps, the overall expected current might be calculated as 0.18+0.25+0.08=0.51 amps using the range minimum values. Alternatively, the midpoints of 0.2, 0.3, and 0.1 amps could be summed to arrive at 0.6 amps. The particular method of combining ranges may be selected to achieve the desired accuracy and anomaly detection sensitivity. Moreover, depending upon how the profiles are combined, different thresholds or varying threshold techniques may be used to determine when a current anomaly is detected.

At step 610, the client computing device obtains a real-time measurement of the overall current consumption when the identified software applications are executing in their respective determined operational states. The current consumption may be measured using ammeters, current sense resistors, power monitoring integrated circuits, or other current measurement means. The overall observed current draw of the device is captured for analysis.

At step 612, the client computing device compares the real-time current measurement to the expected overall current consumption calculated from the current consumption profiles in step 608. The determination of whether a current anomaly exists, and whether the current anomaly represents an unwanted software process, is based on comparing the measured current against the expected current and applying thresholding criteria. Here, satisfying the threshold criteria means the observed current exceed a relevant threshold. As described previously, different thresholding techniques may be utilized.

At method operation 614, if the observed current does not exceed the expected current, thus not satisfying the threshold criteria, the method operation ends, at least temporarily. The threshold criteria utilized at step 614 to determine if a current anomaly exists. and whether an anomaly represents an undesirable or unwanted software process, may be defined in various ways. In one embodiment, the threshold may be set equal to the expected overall current consumption, such that any amount above this indicates an anomaly. Alternatively, the threshold may be a fixed value set slightly above the expected current to allow minor fluctuations without triggering an anomaly state. As another option, the threshold may be determined dynamically based on the number and type of applications running or other context to provide some tolerance above the expected current.

In some implementations, multiple tiered thresholds may be defined. A first threshold may allow for minor discrepancies within a predefined error margin. A second higher threshold may define a “grey area” where further analysis is performed to scrutinize the anomaly and confirm if it represents a threat. Finally, a third definitive threshold may be set, above which any current measurement is automatically interpreted as being caused by malicious or unwanted software processes. As shown in FIG. 6, at method operation 616, when some threshold criteria is satisfied, the computing device may perform additional analyses, or may take one of a number of different remedial actions, which may depend upon the nature of the detected threat. Specifically, with some embodiments, the remedial action that is performed may be based on additional current analysis at a hardware resource level.

As an additional technique for analyzing current when an anomaly is suspected, the executing software applications may be systematically terminated or closed, and an overall current measurement taken with no active applications running. This current level with no active apps serves as a baseline default for the particular hardware configuration, capturing the minimal current draw when only essential background system processes are active. The measured default current level can be compared to the current consumption measured when anomalies were detected. If the current with no active applications remains high, this suggests background processes unrelated to the terminated applications are responsible for the excessive current draw. Conversely, if terminating all applications returns current levels close to the expected system baseline, this implies that one or more of the active applications was linked to the anomaly. This application termination approach provides another method for isolating the source of a current consumption anomaly when initial analysis is inconclusive.

In cases where terminating all active applications at once does not successfully remediate an identified current anomaly, the system can employ a selective, iterative application termination approach to isolate the specific software application responsible for the abnormal current In this technique, active applications are individually terminated in a selective manner while current draw is monitored after each termination. For example, if three applications are active when excess current is detected, a first application would first be terminated and the overall device current consumption measured. If the current anomaly persists, a second application would then be terminated, and current measured again. This iterative process proceeds by closing one active application at a time and checking overall current consumption against expected current consumption until the anomaly dissipates, indicating the recently terminated application was linked to the abnormal current. By using selective termination and current measurement, the system can isolate the specific application associated with the current anomaly through an efficient testing process, rather than requiring all applications to be terminated simultaneously. This targeted application isolation enables customized responses based on the software identified as the source of the anomaly

While the method steps are depicted in FIG. 6 as a sequential series, one skilled in the art will recognize that several of the steps may be performed concurrently or in parallel in order to achieve real-time anomaly detection. Of particular importance is that the overall current consumption measurement obtained in step 610 occurs during the period of time when the software applications identified in step 602 are executing in the operational modes determined in step 604, corresponding to the current consumption profiles accessed in step 606. The overall current measurement and calculation of expected current must align temporally. Therefore, in some implementations, time stamps may be associated with the current measurements, application states, and consumption profiles to enable alignment and synchronized comparison.

### Machine and Software Architecture

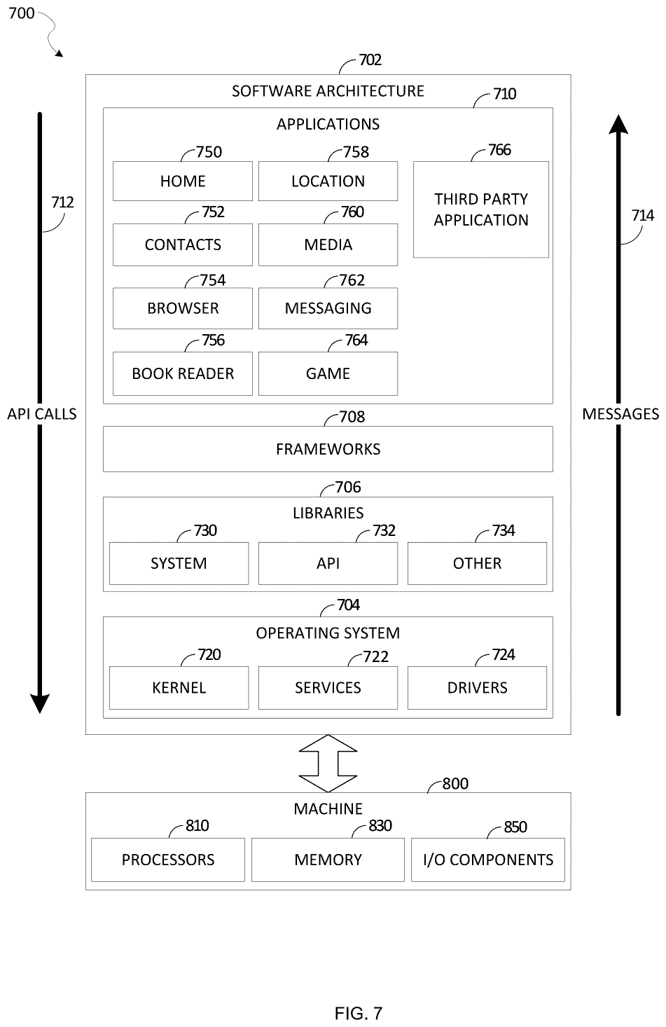

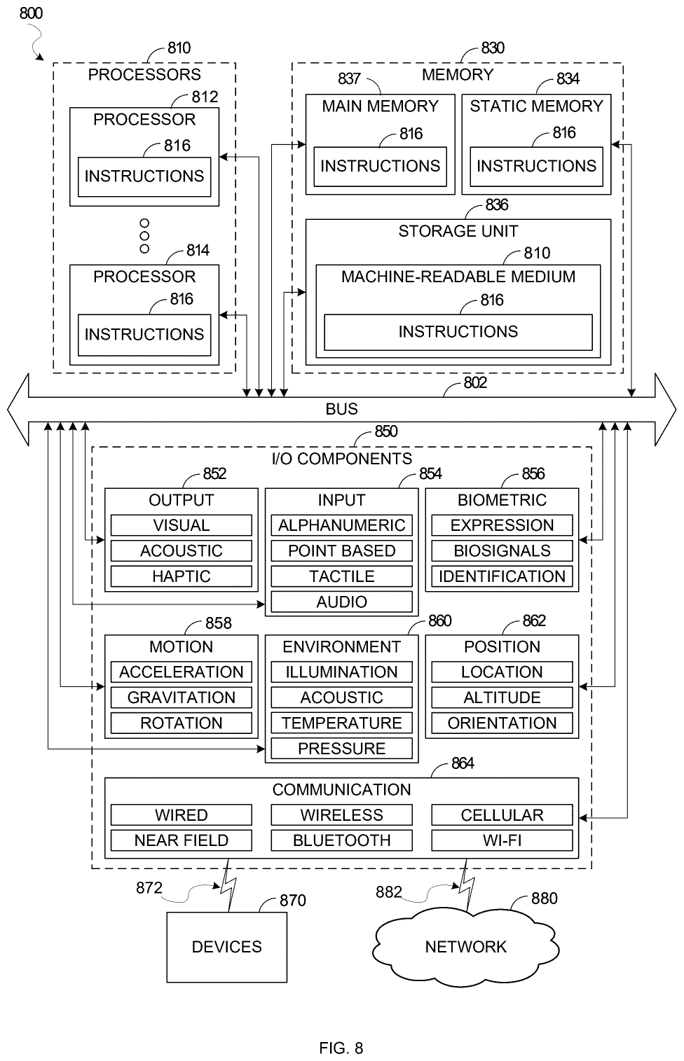

FIG. 7 is a block diagram 700 illustrating a software architecture 702, which can be installed on any of a variety of computing devices to perform methods consistent with those described herein. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 802 includes layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 706 can also include a wide variety of other libraries 834 to provide many other APIs to the applications 710.

The frameworks 708 provide a high-level common infrastructure that can be utilized by the applications 710, according to some embodiments. For example, the frameworks 708 provide various GUI functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 712 provided by the operating system 704 to facilitate functionality described herein.

FIG. 8 illustrates a diagrammatic representation of a machine 800 in the form of a computer system within which a set of instructions may be executed for causing the machine to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example the instructions 816 may cause the machine 800 to execute any one of the methods or algorithmic techniques described herein. Additionally, or alternatively, the instructions 816 may implement any one of the systems described herein. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 916 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836, all accessible to the processors 810 such as via the bus 802. The main memory 830, the static memory 834, and storage unit 836 store the instructions 816 embodying any one or more of the methodologies or functions described herein. The instructions 916 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical key board, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 830, 832, 834, and/or memory of the processor(s) 810) and/or storage unit 836 may store one or more sets of instructions and data structures (e.g., software) embodying or utilized by any one or more of the methodologies or functions described herein. These instructions (e.g., the instructions 816), when executed by processor(s) 810, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices: magnetic disks such as internal hard disks and removable disks: magneto-optical disks: and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 may be transmitted or received over the network 980 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method for detecting anomalous application behavior in a computing device, the method comprising:
identifying one or more software applications currently executing on the computing device;
for each software application executing on the computing device, determining an operational state of the application;
accessing a plurality of current consumption profiles to obtain a current consumption profile for the operational state of each executing software application, each current consumption profile indicating an expected current consumption by the executing software application when operating in the determined operational state;
combining the current consumption profiles for the executing software applications and operational states to calculate an expected overall current consumption;
obtaining a measurement of an overall current consumption of the computing device when the one or more software applications are executing in their respective determined operational states;
comparing the measurement of the overall current consumption of the computing device to the expected overall current consumption; and
based upon the comparison of the overall current consumption and the expected current consumption, determining an excess current consumption state that indicates anomalous behavior representing a likelihood that a software application is behaving abnormally on the computing device.

2. The method of claim 1, wherein the plurality of current consumption profiles are obtained by querying a current consumption profile database that includes, for each software application in a plurality of software applications, values for one or more current consumption profiles for an operational state of the software application, the operational state representing a function being performed by the software application, the function comprising:
facilitating an audio-based communication session;
facilitating a video-based communication session;
streaming audio content;
streaming video content;
executing an interactive gaming application;
actively transferring data;
playing locally stored audio content;
playing locally stored video content;
performing an intensive computational task;
transitioning between two operational states; and
an idle state in which the application is open but not actively being used.

3. The method of claim 1, further comprising:
subsequent to determining that the excess current consumption indicates anomalous behavior representing a high likelihood that an unknown software application is executing on the computing device, automatically initiating an action comprising:
disconnecting the computing device from a network;
shutting down the computing device;
generating an alert message to a user of the computing device;
switching execution of a software application to a different computing device;
initiating a corrective action in a client application executing on the computing device;
initiating a corrective action in a backend server application communicating with the client application;
executing a predefined remedial procedure to address the anomalous current consumption; or
any combination thereof.

4. The method of claim 1, further comprising:
when the measurement of the overall current consumption exceeds the expected overall current consumption but is less than a threshold amount:
accessing, for each executing software application, a sub-component current consumption profile indicating an expected current consumption for each of a plurality of hardware components utilized by the application;
determining an overall expected current consumption for each hardware component based on the sub-component current consumption profiles;
obtaining a measurement of an actual current consumption for each of the plurality of hardware components;
comparing, for each hardware component, the measurement of the actual current consumption to the overall expected current consumption for that component; and
when the measurement of the actual current consumption for a hardware component exceeds the overall expected current consumption for that component, initiating a corrective action associated with the software application utilizing the hardware component.

5. The method of claim 2, wherein the current consumption profiles in the database include, for one or more operational states of each application, multiple current consumption profiles corresponding to different configurations or versions of the application.

6. The method of claim 1, wherein obtaining the measurement of overall current consumption of the device comprises periodically sampling the current consumption at a predefined frequency.

7. The method of claim 6, wherein the frequency at which the current consumption is sampled depends on whether the device is in an idle state or actively executing applications.

8. The method of claim 1, further comprising:
when an anomaly is detected, increasing a sampling rate or frequency at which the overall current consumption of the device is measured for a period of time in order to collect additional current measurements for further analysis of the anomaly.

9. A device comprising:
at least one processor; and
at least one memory storage device storing instructions thereon, which, when executed by the at least one processor, cause the device to perform operations comprising:
identifying one or more software applications currently executing on the device;
for each software application executing on the device, determining an operational state of the application;
accessing a plurality of current consumption profiles to obtain a current consumption profile for the operational state of each executing software application, each current consumption profile indicating an expected current consumption by the executing software application when operating in the determined operational state;
combining the current consumption profiles for the executing software applications and operational states to calculate an expected overall current consumption;
obtaining a measurement of an overall current consumption of the device when the one or more software applications are executing in their respective determined operational states;
comparing the measurement of the overall current consumption of the device to the expected overall current consumption; and
based upon the comparison of the overall current consumption and the expected overall current consumption, determining an excess current consumption state that indicates anomalous behavior representing a likelihood that a software application is behaving abnormally on the device.

10. The device of claim 9, wherein the plurality of current consumption profiles are obtained by querying a current consumption profile database that includes, for each software application in a plurality of software applications, values for one or more current consumption profiles for an operational state of the software application, the operational state representing a function being performed by the software application, the function comprising:
facilitating an audio-based communication session;
facilitating a video-based communication session;
streaming audio content; streaming video content;
executing an interactive gaming application;
actively transferring data; playing locally stored audio content;
playing locally stored video content; performing an intensive computational task;
transitioning between two operational states; and
an idle state in which the application is open but not actively being used.

11. The device of claim 9, wherein the operations further comprise:
subsequent to determining that the excess current consumption indicates anomalous behavior representing a high likelihood that an unknown software application is executing on the device, automatically initiating an action comprising:
disconnecting the device from a network;
shutting down the device; generating an alert message to a user of the device;
switching execution of a software application to a different device;
initiating a corrective action in a client application executing on the device;
initiating a corrective action in a backend server application communicating with the client application;
executing a predefined remedial procedure to address the anomalous current consumption; or,
any combination thereof.

12. The device of claim 9, wherein the operations further comprise:
when the measurement of the overall current consumption exceeds the expected overall current consumption but is less than a threshold amount:
accessing, for each executing software application, a sub-component current consumption profile indicating an expected current consumption for each of a plurality of hardware components utilized by the application;
determining an overall expected current consumption for each hardware component based on the sub-component current consumption profiles;
obtaining a measurement of an actual current consumption for each of the plurality of hardware components;
comparing, for each hardware component, the measurement of the actual current consumption to the overall expected current consumption for that component; and
when the measurement of the actual current consumption for a hardware component exceeds the overall expected current consumption for that component, initiating a corrective action associated with the software application utilizing the hardware component.

13. The device of claim 10, wherein the current consumption profiles in the database include, for one or more operational states of each application, multiple current consumption profiles corresponding to different configurations or versions of the application.

14. The device of claim 9, wherein obtaining the measurement of overall current consumption of the device comprises periodically sampling the current consumption at a predefined frequency.

15. The device of claim 14, wherein the frequency at which the current consumption is sampled depends on whether the device is in an idle state or actively executing applications

16. The device of claim 9, wherein the operations further comprise:
when an anomaly is detected, increasing a sampling rate or frequency at which the overall current consumption of the device is measured for a period of time in order to collect additional current measurements for further analysis of the anomaly.

17. A non-transitory computer-readable medium storing instructions thereon which, when executed by one or more processors, cause a computing device to perform operations comprising:
identifying one or more software applications currently executing on the computing device;
for each software application executing on the computing device, determining an operational state of the application;
accessing a plurality of current consumption profiles to obtain a current consumption profile for the operational state of each executing software application, each current consumption profile indicating an expected current consumption by the executing software application when operating in the determined operational state;
combining the current consumption profiles for the executing software applications and operational states to calculate an expected overall current consumption;
obtaining a measurement of an overall current consumption of the computing device when the one or more software applications are executing in their respective determined operational states;
comparing the measurement of the overall current consumption of the computing device to the expected overall current consumption; and
based upon the comparison of the overall current consumption and the expected overall current consumption, determining an excess current consumption state that indicates anomalous behavior representing a likelihood that a software application is behaving abnormally on the device.

18. The non-transitory computer-readable medium of claim 17, wherein the operations further comprise:
when the measurement of the overall current consumption exceeds the expected overall current consumption but is less than a threshold amount:
accessing, for each executing software application, a sub-component current consumption profile indicating an expected current consumption for each of a plurality of hardware components utilized by the application;
determining an overall expected current consumption for each hardware component based on the sub-component current consumption profiles;
obtaining a measurement of an actual current consumption for each of the plurality of hardware components;
comparing, for each hardware component, the measurement of the actual current consumption to the overall expected current consumption for that component; and
when the measurement of the actual current consumption for a hardware component exceeds the overall expected current consumption for that component, initiating a corrective action associated with the software application utilizing the hardware component.

19. The non-transitory computer-readable medium of claim 17, wherein obtaining the measurement of overall current consumption of the device comprises periodically sampling the current consumption at a predefined frequency.

20. The non-transitory computer-readable medium of claim 17, wherein the operations further comprise:
when an anomaly is detected, increasing a sampling rate or frequency at which the overall current consumption of the device is measured for a period of time in order to collect additional current measurements for further analysis of the anomaly.
